(19) United States
(12) Patent Application Publication
(10) Pub. No.: US 2003/0228044 A1
(43) Pub. Date: Dec. 11, 2003

(54) Radiographic marker location

(75) Inventors: Srinivasan Gopalasamy, Pleasanton, CA (US); Alexander Berestov, San Jose, CA (US)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Ohta-Ku (JP)

(21) Appl. No.: 10/161,691

(22) Filed: Jun. 5, 2002

(51) Int. Cl. G06K 9/00

(52) U.S. Cl. 382/132; 382/294

(57) ABSTRACT

One or more fiducial marker projections are located in a radiographic image, where the radiographic image is stored as digital image data. The digital image data is filtered with a grayscale morphological filter to enhance potential fiducial marker projections. The filtered digital image data is segmented into one or more seed regions, where each of the one or more seed regions contains a potential fiducial marker projection. The potential fiducial marker projection within each of the one or more seed regions is analyzed and verified and a location of a fiducial marker projection within the radiographic image is determined for each verified potential fiducial marker projection.

### BACKGROUND OF THE INVENTION

1. Field of the Invention

The present invention concerns the detection of objects within digital images and in particular concerns the detection of fiducial marker projections within digital radiographic images.

2. Description of the Related Art

Modern medical imaging techniques provide methods for obtaining a wide variety of information on subjects of radiographic imaging. For example, stereo x-ray imaging, digital tomosynthesis, multi-modal image fusion and image stitching all provide additional information on a subject that is unavailable using a single standard radiographic image. Each of these techniques utilizes multiple radiographic images of a subject and requires that a correspondence between the multiple radiographic images be established. Determining the correspondence between specific points in multiple images is known as image registration.

Fiducial markers are often used in radiographic imaging for the purpose of image registration. By placing fiducial markers on or near a subject, marker projections are formed in radiographic images taken of the subject. Using the precise locations of the marker projections within the radiographic images, the radiographic images can be registered with each other so as to establish a correspondence between specific points in those radiographic images. Once the correspondence between the radiographic images has been determined, the radiographic images can be processed to provide information using one of the techniques mentioned above.

Determining the precise location of marker projections in the radiographic images is crucial for accurate image registration. Typically a skilled technician must visually examine the radiographic images to detect the marker projections and then use cross-wires or some other similar method to determine their precise location within the images. This manual process can be tedious and often leads to inaccurate and inconsistent results.

Alternatively, digital image processing techniques have been developed to assist in detecting the location of marker projections within digital medical images. For example, U.S. Pat. No. 5,799,099 (“Wang”) teaches a two-stage process for identifying markers within a medical volume image and for determining their location. However, processing techniques like the one disclosed in Wang encounter difficulties in accurately locating marker projections within digital medical images.

Marker projections are often near or overlap other projections in an image, such as bone projections, thereby making it difficult to distinguish the marker projections from other projections. Additionally, marker projections may not be the brightest regions in the image or the intensity of the marker projections may vary. For these reasons, processing techniques typically have difficulty accurately identifying marker projections. For example, Wang teaches the use of a type of threshold determination wherein a threshold filter is applied to sub-sampled image data to generate a binary image. The binary image is then processed to identify possible marker projections. Identifying possible marker projections using Wang's threshold determination often leads to inaccurate or failed identification of marker projections for the reasons mentioned above.

### SUMMARY OF THE INVENTION

The present invention addresses the foregoing problems by employing morphological techniques rather than threshold determination techniques to identify potential fiducial marker projections in a radiographic image. Initially, the invention applies a grayscale morphological filter to radiographic image data in order to enhance potential fiducial marker projections so that seed regions containing the potential fiducial marker projections can be identified. Using the identified seed regions, the potential fiducial marker projections within the radiographic image data are further processed to verify which are actual fiducial marker projections and which are false locations. In this manner, fiducial marker projections are accurately detected and distinguished from other types of projections within the radiographic image.

According to one aspect of the present invention, one or more fiducial marker projections are located in a radiographic image, where the radiographic image is stored as digital image data. The digital image data is filtered with a grayscale morphological filter to enhance potential fiducial marker projections. The filtered digital image data is segmented into one or more seed regions, where each seed region contains a potential fiducial marker projection. Each potential fiducial marker projection is analyzed and verified, and a location is determined for each verified potential fiducial marker location.

Preferably, the digital image data is sub-sampled and then filtered by the grayscale morphological filter, after which the filtered sub-sampled image data is segmented into one or more sub-sampled seed regions. A centroid is computed for each seed region and a sub-image seed region is cropped from the digital image data for each centroid, where each sub-image seed region contains a potential fiducial marker projection. Each sub-image seed region is filtered with a threshold filter using a designated threshold setting. The potential fiducial marker projection in each sub-image seed region is then analyzed to verify the potential fiducial marker projection.

In addition, the present invention preferably repeats the threshold filtering of each sub-image seed region at a different designated threshold setting and repeats the analyzing of the potential fiducial marker projection if the potential fiducial marker projection is not verified. The threshold filtering and analyzing are repeated at each of a series of designated threshold settings until the potential fiducial marker projection is verified. If the potential fiducial marker projection is not verified after all of the series of designated threshold settings have been applied, the potential fiducial marker projection is designated as a false location.

The present invention preferably analyzes the potential fiducial marker projections by verifying a shape of the potential fiducial marker projection based on a set of fiducial marker features.

This brief summary of the invention has been provided so that the nature of the invention may be understood quickly. A more complete understanding of the invention can be obtained by reference to the detailed description of the preferred embodiment in connection with the drawings.

### BRIEF DESCRIPTION OF THE DRAWINGS

FIG. 1 is a block diagram depicting the general operating modules of the present invention.

FIG. 2 is a block diagram depicting the internal architecture of a computing device used to implement the present invention.

FIG. 3 is a block diagram depicting the contents of a computer-readable medium used in the present invention.

FIG. 4 is a flowchart depicting a process of locating seed regions according to the present invention.

FIG. 5 is a flowchart depicting a process of segmenting seed regions according to the present invention.

FIG. 6 is a flowchart depicting a process of locating fiducial marker projections according to the present invention.

FIG. 7 is a flowchart depicting a process of segmenting potential fiducial marker projections according to the present invention.

### DETAILED DESCRIPTION OF THE INVENTION

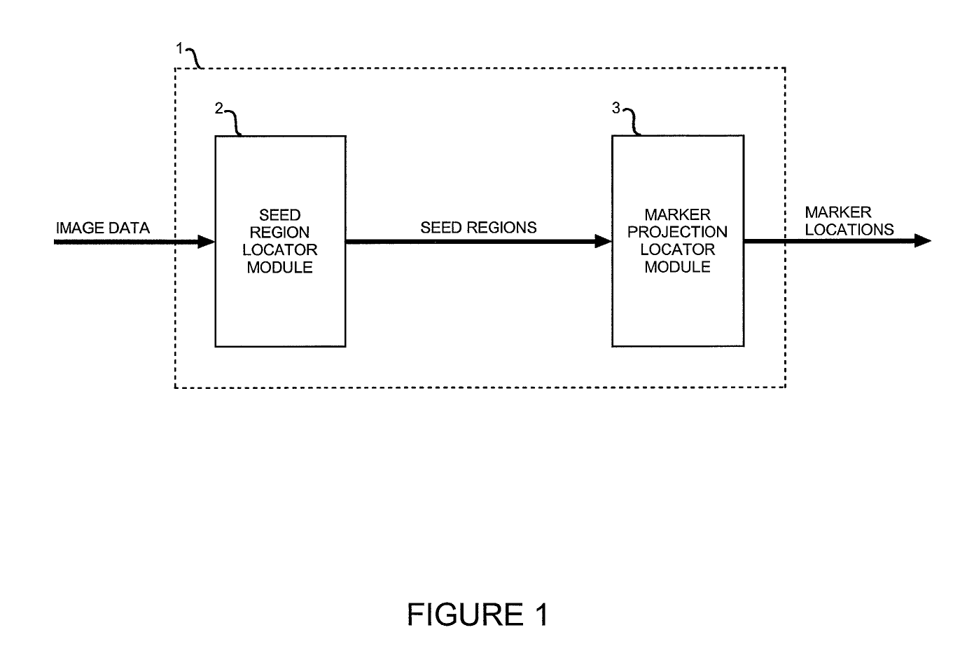

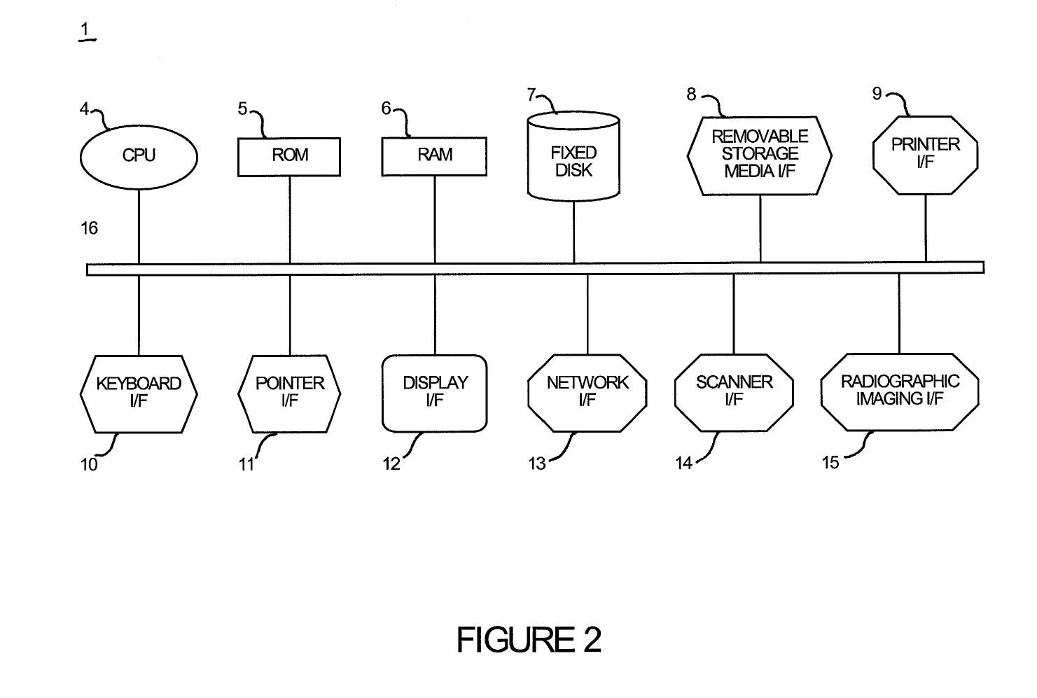

FIG. 1 is a block diagram depicting the general operating modules of the present invention. The operating modules are implemented using a computing device 1 and include two primary modules: a seed region locator module 2 and a marker projection locator module 3. Computing device 1 may be a personal computer, a workstation, or some other type of general or special purpose computing system. For purposes of this description, a description and drawing of an external view of computing device 1 have been omitted. However, a detailed description of the internal architecture of computing device 1 will be provided below with reference to FIG. 2.

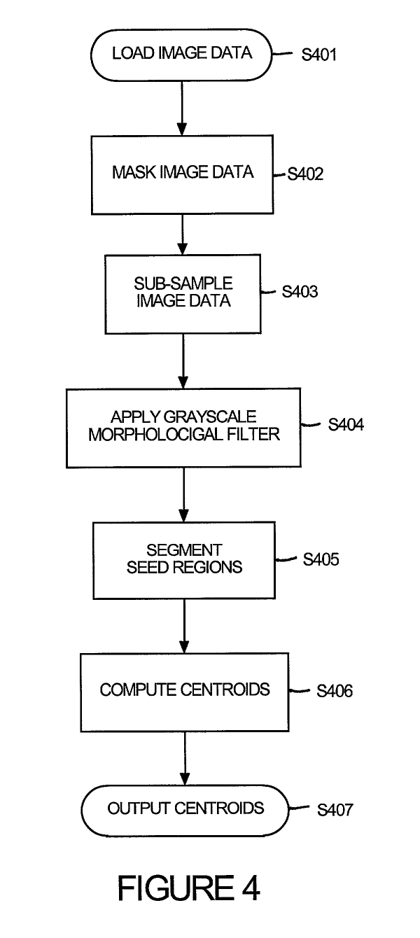

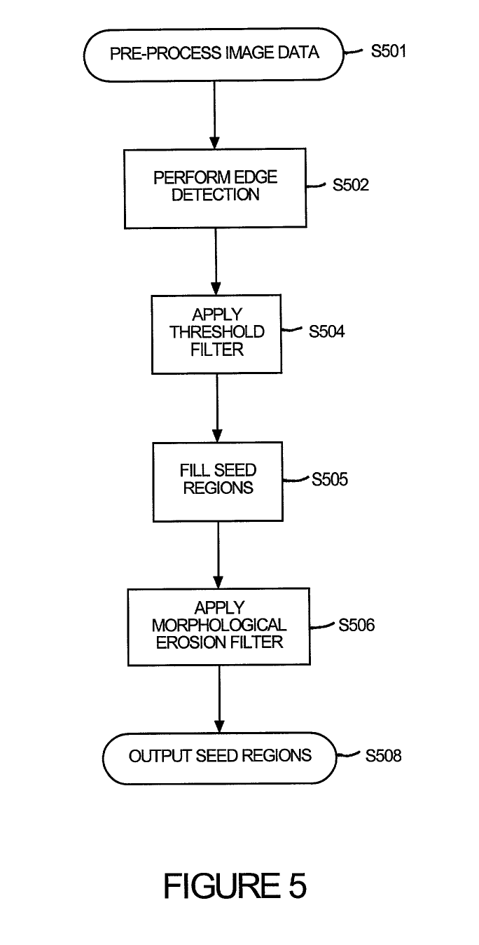

The operation of the invention involves inputting digital image data of a radiographic image into computing device 1 in order to obtain precise locations of one or more fiducial marker projections located in the radiographic image. As depicted in FIG. 1, the digital image data is input into seed region locator module 2. Seed region locator module 2 processes the digital image data to determine the locations of seed regions containing potential fiducial marker projections. A detailed description of the processing performed by seed region locator module 2 will be provided below with reference to FIGS. 4 and 5.

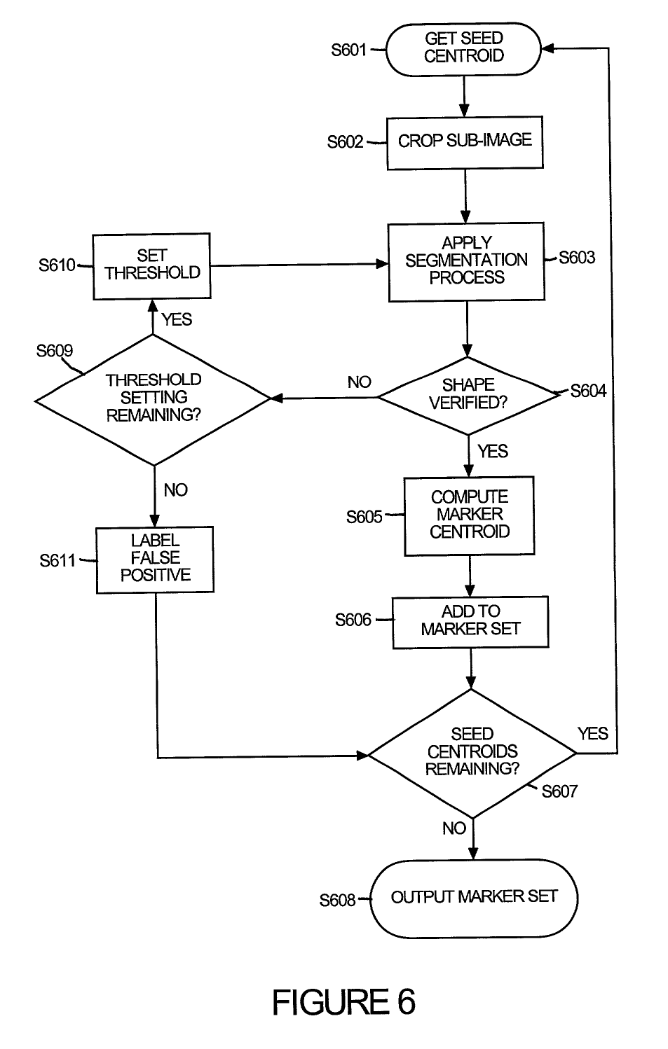

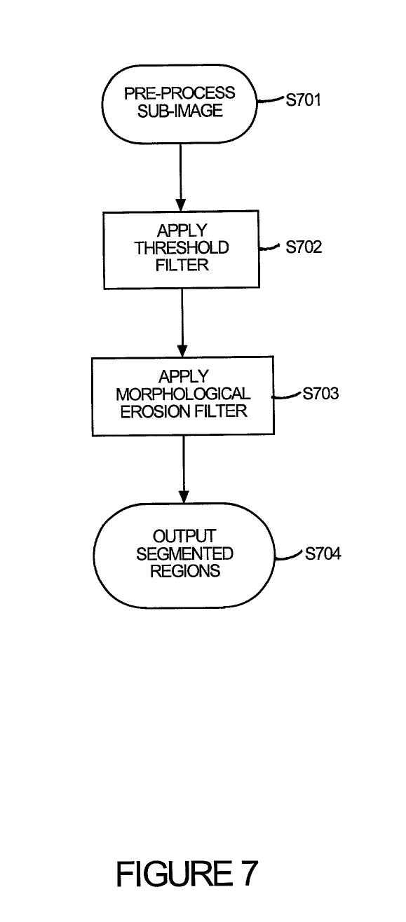

The locations of the seed regions determined by seed region locator module 2 are input into marker projection locator module 3. Marker projection locator module 3 processes the digital image data in the areas of the seed regions determined by seed region locator module 2 to determine which of the potential fiducial marker projections are verified fiducial marker projections and which are false identifications. Marker projection locator module 3 then determines and outputs the precise locations of the verified fiducial marker projections. A detailed description of the processing performed by marker projection locator module 3 will be provided below with reference to FIGS. 6 and 7.

FIG. 2 is a block diagram illustrating the internal architecture of computing device 1. Central processing unit (CPU) 4 is a microprocessor that performs control functions for peripherals attached to computing device 1 and executes instructions of software modules being executed by computing device 1. CPU 4 is interfaced to bus 16 which provides for communication and transfer of data between the components that make up computing device 1.

Read only memory (ROM) 5 stores invariant instruction sequences, such as startup instruction sequences for CPU 4 and basic input/output operating system (BIOS) sequences for controlling peripheral devices connected to computing device 1. Random access memory (RAM) 6 is a run-time memory in which instruction sequences are loaded from fixed disk 7, or another form of computer-readable storage media, by CPU 4 prior to being executed. Additionally, RAM 6 provides memory space for CPU 4 to execute instruction sequences and perform computations.

Fixed disk 7 is a computer-readable storage medium that stores software modules executed by computing device 1, which will be described in more detail below. In addition, fixed disk 7 provides storage space for data received and generated by computing device 1. Removable storage media interface 8 provides access to one or more forms of removable computer-readable storage media. Possible types of removable storage media include, but are not limited to, floppy disks, CD-ROMs, Compacflash, etc.

As shown in FIG. 2, computing device 1 also includes a variety of interfaces in communication with bus 16 for connecting and communicating with different peripheral devices. Keyboard interface 10 and pointer interface 11 provide means for connecting and receiving user input from a keyboard or a pointing device such as a mouse. Input devices for computing device 1 are not limited to a keyboard and mouse and may include other devices such as a touch-screen system or a light-pen device. Display interface 12 provides means for connecting computing device 1 to a display device, such as a CRT monitor or flat-panel display, and for communicating with the display device to display data and processing results generated by computing device 1 as well as user interfaces. Printer interface 9 provides means for communicating with a printing device such as a laser printer to output data and processing results generated by computing device 1.

Network interface 13 provides means for computing device 1 to connect to and communicate with other devices connected to a common network such as a wide or local area network, intranet or internet. Scanner interface 14 provides means for connecting to and communicating with a scanning device, with which images can be scanned and converted into a digital format for storage and further processing by computing device 1. Radiographic imaging interface 15 provides means for communicating with a radiographic imaging system used to obtain radiographic images of a subject.

The peripheral devices mentioned above are provided as examples of possible peripheral devices connectable to computing device 1. It is to be understood, however, that other peripheral devices in addition to those mentioned above may be connected to computing device 1.

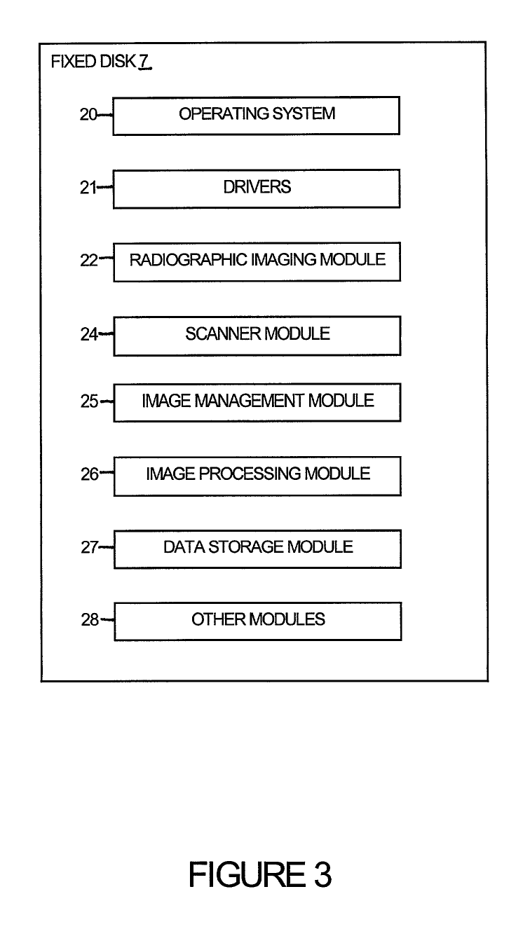

FIG. 3 is a block diagram depicting the contents of fixed disk 7. Fixed disk 7 stores software modules that include operating system (OS) 20, drivers 21, radiographic imaging module 22, scanner module 24, image management module 25, image processing module 26, data storage module 27 and other modules 28. OS 20 is an operating system that manages applications running on computing device 1 as well as the various components that make up computing device 1. OS 20 may be a windowing operating system, such as Windows 2000, or may be a UNIX/Linux based operating system. Drivers 21 is a set of software drivers to facilitate communication between applications running on computing device 1 and peripherals attached to computing device 1.

Radiographic imaging module 22 is software for controlling and communicating with a radiographic imaging system connected to computing device 1 through radiographic imaging interface 15. By executing radiographic imaging module 22, radiographic images of a subject can be obtained and received by computing device 1 in accordance with commands entered by a user. Scanner module 24 is software for controlling a scanning device connected to computing device 1 through scanner interface 14. By executing scanner module 24, a user can control a connected scanning device to scan one or more images and store those images as digital data in computing device 1.

Image management module 25 is software for managing the storage of radiographic images of particular subjects together with data associated with each radiographic image. The data associated with each radiographic image includes, but is not limited to, identification of the subject, relative positions of the radiographic images with respect to the subject, determined locations of fiducial markers in the radiographic images, etc.

Image processing module 26 is software for processing digital image data. Image processing module 26 performs a variety of functions utilized in the process of locating fiducial marker projections in digital radiographic images. Possible functions include the application of filters such as morphological filters and threshold filters, edge detection, centroid calculation, shape verification, etc. These functions, as well as others involved in the present invention, will be described in more detail below.

Data storage module 27 stores digital radiographic images received and processed by computing device 1 as well as data associated with respective radiographic images. Finally, other modules 28 includes software modules in addition to those mentioned above that may be utilized by a user of computing device 1. For example, software modules for processing radiographic images to implement multiple radiographic image registration, radiographic image stitching, stereo x-ray imaging, or x-ray tomosynthesis might be included in other modules 28. Other software modules might also include word processors, spreadsheets or specialty software unique to a particular user's needs.

The contents of fixed disk 7 are not limited to those described above. Additionally, one or more of the modules described above may be stored on and executed from other types of computer-readable storage media, such as a floppy disk or CD-ROM, or from a local or wide area network, intranet or internet.

FIG. 4 depicts the processing performed by seed region locator module 2. Briefly, as shown in FIG. 4, image data is loaded and pre-processed by masking and sub-sampling the image data. The sub-sampled image data is then filtered using a grayscale morphological filter and segmented into seed regions. Finally, centroids for the seed regions are calculated and output to marker projection locator module 3.

In more detail, in step S401, image data in the form of digital radiographic image data is loaded into the seed region locator module 2 being executed on computing device 1 for processing. The digital radiographic image data may be obtained and loaded in computing device 1 from any one of multiple sources. For example, digital radiographic images may be obtained using a radiographic imaging system connected to radiographic imaging interface 15 and loaded for processing once the digital radiographic image has been captured. Alternatively, previously obtained radiographic images may be scanned using a scanning device connected to scanner interface 14 with the scanned digital radiographic image data being loaded for processing. Other possible sources include previously scanned or obtained digital radiographic images being stored and retrieved from fixed disk 7, stored and retrieved from a form of removable storage media, or transferred to computing device 1 over a local or wide area network, intranet or internet via network interface 13.

In steps S402 and S403, the loaded digital radiographic image data is pre-processed by masking and sub-sampling the digital radiographic image data. Masking of the image data is performed in step S402 to remove portions of the digital radiographic image data that are known not to contain fiducial marker projections of interest. For example, if a border around the subject of the radiographic image is large, masking may be applied to remove the border and reduce the amount of image data being processed. Alternatively, fiducial markers located around the wrist of a subject may be of interest while a radiographic image of the entire arm is captured in the digital radiographic image data. In this case, masking may be applied to crop the image data so that only the area of the image data surrounding the wrist is subjected to further processing. It is to be understood, however, that masking of the digital radiographic image data is an optional step in the process of the present invention and that the desired results generated by the process described herein can be obtained without masking the digital radiographic image data in this step.

The masked digital radiographic image data is sub-sampled in step S403 to reduce the amount of image data being processed by seed region locating module 2. In this manner, the processing load on computing device 1 is reduced during the initial stages of the process in which seed regions are identified. Accordingly, seed regions of the digital radiographic image data can be located quicker and more efficiently than if the complete digital radiographic image data were processed at this stage.

Sub-sampling of the image data can be performed using any one of a number of known techniques. In this embodiment of the invention, the image data is sub-sampled by scaling the image data by a predetermined factor. For example, the image data may be scaled by a factor of four, thereby reducing the amount of data being processed to one-fourth of the original amount. The invention is not limited to scaling the image data by a factor of four and may scale the image data using other factors such as a factor of eight.

In step S404, a grayscale morphological filter is applied to the sub-sampled image data to enhance fiducial marker projections. In this embodiment of the invention, a grayscale morphological top-hat filter is applied to the sub-sampled image data. The grayscale morphological top-hat filter is a two-step filter in which the sub-sampled image data is first filtered using a grayscale morphological close filter and then the difference between the sub-sampled image data and the filtered sub-sampled image data is obtained.

The grayscale morphological close filter filters the sub-sampled image data to remove those portions of the image data that are likely to contain fiducial marker projections. The grayscale morphological close filter uses a kernel in the filtering process that is configured based on the maximum possible size of fiducial marker projections in the sub-sampled image data. Once those portions of the image data that are likely to contain fiducial marker projections have been removed, the difference between the filtered sub-sampled image data and the pre-filtered sub-sampled image data is obtained. In this manner, sub-sampled image data is produced in which potential fiducial marker projections have been enhanced and regions of the sub-sampled image data which are not likely to contain a fiducial marker projection have been removed.

In step S405, the enhanced image data generated in step S404 is segmented into seed regions containing potential fiducial marker projections for further processing. FIG. 5 is a flowchart depicting the segmentation process performed in step S405 of FIG. 4. Briefly, as shown in FIG. 5, the enhanced image data is pre-processed and edge detection techniques are applied to identify outlines of shapes within the image data. The identified outlines of shapes are then filtered with a threshold filter. The shapes defined by the outlines are then filled and separated into seed regions using a morphological erosion filter. Finally, the seed regions are output.

In more detail, in step S501, the enhanced image data is pre-processed by adjusting the intensity of the enhanced image data and applying a smoothing filter to further enhance potential fiducial marker projections. In adjusting the intensity, the range of intensity values within the enhanced image data is scaled to have a full range of intensity. In this embodiment of the invention, intensity adjustment is performed using the following formulas:

scale=255/(Pmax−Δ) (1)

Pout=(Pin−Δ)×scale (2)

Pmax is the maximum intensity value of the pixels in the enhanced image data prior to adjusting the intensity. Pin is the intensity value of a pixel in the enhanced image data prior to adjusting the intensity. Pout is the intensity value of a pixel after adjusting the intensity. Δ is a design parameter that is set to remove residues in the enhanced image data produced during the grayscale morphological filtering. In this embodiment Δ is set to a value of four, however, other values for Δ may also be used depending on the particular image data. The intensity adjustment is performed by first determining Pmax from the enhanced image data. The determined value of Pmax is then used together with the set value for Δ to obtain the scale using formula (1). Finally, each pixel in the enhanced image data is adjusted using formula (2). In this example, the intensity was scaled to a full range of 0 to 255. Alternatively, the intensity could be scaled to have a range of intensity values equivalent to the range of intensity values in the original image data. Once the intensity of the image data has been adjusted, the image data is smoothed using a smoothing filter in preparation for performing edge detection.

The above description for adjusting the intensity values in the image data is only one example of an adjustment method. It is to be understood that other known methods for adjusting and scaling intensity values of image data may also be applied for pre-processing the image data.

In step S502, an edge-detection filter is applied to the adjusted image data produced in step S501. The edge-detection filter filters the image data to produce grayscale outlines of shapes contained in the image data. The edge-detection filter locates the shape outlines by detecting jumps in pixel values within the image data.

In step S504, a threshold filter is applied to the shape outlines produced in step S502. The threshold filter is applied using a threshold value obtained by dividing the range of intensity values set in step S501 by a predetermined value. For example, the predetermined value could be set to four, which would result in the threshold filter removing those portions of the shape outlines in the image data having a value less than one-quarter of the set maximum intensity value. In this manner, the grayscale shape outlines are enhanced for further processing.

The method for applying the threshold filter described above is only one example of a threshold determination method. It is to be understood, however, that the threshold filter applied in step S504 may utilize other predetermined values as well as other threshold determination methods.

In step S505, the enhanced shape outlines are examined to determine which outlines form a closed shape. Specifically, the shape outlines are examined to determine which are continuous, having no beginning or end, and which are merely line segments. For those shape outlines that are continuous, the area enclosed by the outline is filled by setting the value of the pixels bounded by the outline to a value of the pixels making up the shape outline. In this manner, seed regions are formed by the filled shapes, where each seed region contains a potential fiducial marker projection.

In step S506 a grayscale morphological erosion filter is applied to the seed regions formed by the filled shapes. The grayscale morphological erosion filter uses a small kernel to separate adjoining seed regions. In this embodiment, the kernel was set to a size equivalent to one or two pixels. The segmentation process is completed in step S508 by outputting the generated seed regions.

Returning to the process depicted in FIG. 4, in step S406 a centroid for each seed region of the image data is calculated and added to a set of seed regions for the particular digital radiographic image data. Finally, in step S408, the set of centroids for all of the located seed regions is output to the marker projection locator module 3 for further processing.

As described above, the preferred embodiment of the present invention masks and sub-samples the image data prior to processing the image data to determine seed regions. In this manner, the invention efficiently locates potential seed regions without requiring extensive processing power to process the complete digital radiographic image data. In alternative embodiments, however, the complete digital radiographic image data may processed by seed region locator module 2. In particular, seed region locator module 2 may skip sub-sampling the image data in step S403 of the process depicted in FIG. 4, and perform subsequent steps S404 to S407 on the complete digital radiographic image data.

The processing performed by seed region locator module 2 has been described above with reference to FIGS. 4 and 5. The processing by marker projection locator module 3 of the seed regions located by seed region locator module 2 will now be described with reference to FIG. 6 and 7.

FIG. 6 depicts the process of locating marker projections within seed regions as performed by marker projection locator module 3. In brief, as shown in FIG. 6, a sub-image is cropped from the digital radiographic image data based on a centroid for a located seed region. A segmentation process is applied to further enhance the potential fiducial marker projection. Shape verification is performed and a centroid is calculated and added to a marker set for the verified marker projections. If the shape of a potential marker projection is not verified, the segmentation process and shape verification are repeated using a series of threshold settings until the shape verification passes. If shape verification is not successful, the potential marker projection is labeled as a false positive. Once all seed regions have been processed by marker projection module 3, the set of centroids for verified marker projections is output.

In more detail, in step S601, a seed region centroid is obtained from the set output by seed region locator module 2. Unlike the processing performed by seed region locator module 2 in the preferred embodiment, where seed regions were identified from sub-sampled image data, marker projection locator module 3 processes seed regions cropped from the full digital radiographic image data to locate the precise location of fiducial marker projections. In alternative embodiments of the invention, however, marker projection locator module 3 may perform the process depicted in FIG. 6 on seed regions cropped from sub-sampled image data rather than the full image data.

In step S602, a seed region sub-image is cropped from the original digital radiographic image data centered on a location based on the centroid obtained in step S601. In cropping the sub-image, the size of the sub-image must be set to not crop a portion of a fiducial marker projection from the sub-image. In this embodiment of the invention, the size of the sub-image is set to be four times the maximum size of a fiducial marker projection in the image data. It is to be understood, however, that other sizes of sub-images may also be used.

In step S603, a segmentation process is applied to the sub-image to further enhance potential fiducial marker projections within the seed regions. The segmentation process is depicted in the flowchart of FIG. 7. In brief, as shown in FIG. 7, the sub-image is pre-processed and a threshold filter is applied. A morphological erosion filter is applied to generate segmented regions, which are output for further processing.

In more detail, in step S701, the cropped sub-image is pre-processed prior to proceeding with rest of the segmentation process. The pre-processing of the sub-image includes applying a smoothing filter to the sub-image in order to smooth the edges of the shapes contained within the sub-image.

In step S702, a threshold filter is applied to the smoothed sub-image. The threshold filter is set at a designated threshold value in order to segment peak regions within the sub-image. The designated threshold value is one of a set of threshold values used for processing the sub-image. The set of threshold values is obtained based on the range of pixel values within each sub-image. Using the maximum and minimum pixel values within the sub-image, a range of pixel values is defined. The defined range is divided by a designated value and a designated number of threshold values determined, where the threshold values are pixel values equally spaced along the defined range. One of the threshold values in the set is selected and used in applying the threshold filter in step S702. The selected threshold value is then marked within the set so as to not be used in subsequent application of the threshold filter for the particular sub-image.

In step S703, a morphological erosion filter is applied to the sub-image using a small kernel to segment adjoining regions within the sub-image. In addition to segmenting adjoining regions, the morphological erosion filter also is applied to remove noise and white spikes in the sub-image. Finally, in step S704, the segmented regions, which are potential fiducial marker projections, are output for further processing.

Returning to FIG. 6, in step S604, shape verification is performed on the segmented regions output in step S603 to analyze them and determine if they are fiducial marker projections. To determine if a region is a fiducial marker projection, a set of features corresponding to the particular type of fiducial marker used when the radiographic image was obtained is used to analyze the region and verify the shape and size of the potential marker projection.

In this embodiment of the invention, three features are used in the shape verification step performed in step S604. The first feature is the size of the region calculated using the average radius of the region. The size is compared against a designated upper and lower threshold, and if the size of the region falls between the thresholds the region passes the first feature test.

The second feature is based on the circularity of the region. The fiducial markers in this embodiment are typically round and therefore create circular projections in the radiographic image. Accordingly, the more circular a potential fiducial marker projection is, the more likely it is to be an actual fiducial marker projection. The circularity of a region is represented by a parameter derived by first dividing the area of the region by the area of a circle having a radius equal to the average radius of the region, and then subtracting that result from one. The parameter is compared against a predetermined upper and lower threshold, and if the parameter falls between the two thresholds the region passes the second feature test.

The third feature of this embodiment is the maximum distance between points within the region and the centroid used to crop the sub-image. All points within the region are compared with the centroid and the distance between the centroid and the point within the region farthest from the centroid is compared against a threshold value. In order to pass the third feature test, the distance must not exceed the threshold value.

The three feature tests described above are only one example of how shape verification of the regions can be performed. Other known methods for performing shape verification may also be used to determine if a region is an actual fiducial marker projection. In addition, sets of features for different types of fiducial markers and designated thresholds may be loaded and stored in computing device 1 or input by a user through a user interface connected to computing device 1.

The shape of a potential fiducial marker projection in a region is verified if all three of the feature tests described above are passed. If the shape of the potential fiducial marker projection is verified in step S604, a centroid for the fiducial marker projection is calculated in step S605 and added to a marker set in step S606.

Alternatively, if any one of the three feature tests is failed, the shape of the potential fiducial marker projection is not verified in step S604 and the segmentation process of step S603 and the shape verification of step S604 are repeated using different threshold settings, as will be described in more detail below.

Specifically, if the shape of the region is not verified, it is determined in step S609 whether a threshold setting that has not been previously applied remains from the set of threshold values for the particular sub-image. If an additional threshold setting remains, the threshold is set with the new threshold value in step S610 and processing returns to step S603 to apply the segmentation process to the sub-image using the new threshold setting. On the other hand, if all of the threshold values in the set for the particular sub-image have been used, the region is labeled as a false positive in step S611 and processing proceeds to step S607.

Once a centroid for a fiducial marker projection has been added to the marker set in step S606, or a potential fiducial marker projection has been labeled a false positive, it is determined in step S607 if additional seed regions remain from those output by the seed region locator module 2 for the digital radiographic image data being analyzed. If another seed region remains, processing returns to step S601. On the other hand, if no additional seed regions remain for processing, the marker set for the image data is output, where the marker set contains centroids that detail the precise locations of fiducial marker projections within the digital radiographic image data.

The foregoing description sets forth a process for locating fiducial marker projections with a radiographic image. Once locations of fiducial marker projections are known, image registration of multiple radiographic images to determine the correspondence between specific points in the images can be performed. Accordingly, the present invention can be utilized to facilitate further processing for applications such as radiographic image stitching, stereo x-ray imaging and x-ray tomosynthesis. It is to be understood, however, that the present invention is not limited to these applications alone. Other applications requiring image registration may also benefit from the use of the present invention.

The invention has been described with respect to a particular illustrative embodiment. It is to be understood that the invention is not limited to the above-described embodiment and that various changes and modifications may be made by those skilled in the art without departing from the spirit and scope of the invention.

What is claimed is:

1. A method for locating one or more fiducial marker projections in a radiographic image, the radiographic image being stored as digital image data, the method comprising the steps of:
filtering the digital image data with a grayscale morphological filter to enhance potential fiducial marker projections;
segmenting the filtered digital image data into one or more seed regions, each of the one or more seed regions containing a potential fiducial marker projection;
analyzing the potential fiducial marker projection within each of the one or more seed regions to verify the potential fiducial marker projection; and
determining a location of a fiducial marker projection within the radiographic image for each potential fiducial marker projection verified in said analyzing step.

2. A method according to claim 1, the method further comprising the step of:
sub-sampling the digital image data,
wherein said filtering step and said segmenting step are performed on the sub-sampled digital image data.

3. A method according to claim 1, wherein said segmenting step further comprises computing a centroid for each of the one or more seed regions to describe a location of the respective seed region.

4. A method according to claim 3, the method further comprising the step of:
cropping a sub-image seed region from the digital image data for each of the one or more seed regions, each sub-image seed region based on the centroid computed in said segmenting step for the corresponding seed region,
wherein said analyzing step and said determining step are performed on the cropped sub-image seed regions.

5. A method according to claim 1, wherein said analyzing step further comprises applying a threshold filter at a designated setting to each seed region prior to verifying the potential fiducial marker projection within the seed region.

6. A method according to claim 5, the method further comprising the step of:
repeating said analyzing step using a different designated threshold setting if the potential fiducial marker projection is not verified,
wherein said analyzing step is repeated using a series of designated threshold settings until the potential fiducial marker projection is verified.

7. A method according to claim 6, further comprising the step of designating a potential fiducial marker location a false location if the potential fiducial marker location is not verified after all of the series of designated threshold settings have been applied in said repeating step.

8. A method according to claim 1, wherein said segmenting step further comprises the steps of:
adjusting an intensity of the filtered image data;
applying a smoothing filter to the filtered digital image data;
performing edge detection to detect boundaries of one or more seed regions;
filling the detected boundaries of the one or more seed regions; and
applying a morphological erosion filter to separate adjoining seed regions.

9. A method according to claim 1, wherein said analyzing step further comprises verifying a shape of the potential fiducial marker projection based on a set of fiducial marker features.

10. A method according to claim 1, wherein said determining step further comprises calculating a centroid for each verified fiducial marker projection to describe the location of the verified fiducial marker projection.

11. A method according to claim 1, wherein the location of the one or more fiducial marker projections is used for performing multiple radiographic image registration.

12. A method according to claim 1, wherein the location of the one or more fiducial marker projections is used for performing radiographic image stitching.

13. A method according to claim 1, wherein the location of the one or more fiducial marker projections is used for performing stereo x-ray imaging.

14. A method according to claim 1, wherein the location of the one or more fiducial marker projections is used for performing x-ray tomosynthesis.

15. An apparatus for locating one or more fiducial marker projections in a radiographic image, the apparatus comprising:
a program memory for storing process steps executable to perform a method according to any one of claims 1 to 14; and
a processor for executing the process steps stored in said program memory.

16. Computer-executable process steps stored on a computer-readable medium, the computer-executable process steps for locating one or more fiducial marker projections in a radiographic image, the computer-executable process steps comprising process steps executable to perform a method according to any one of claims 1 to 14.
